(19) United States
(12) Patent Application Publication
(10) Pub. No.: US 2008/0151124 A1
(43) Pub. Date: Jun. 26, 2008

(54) Reducing Channel Changing Time for Digital Video Inputs

(75) Inventor: Janghwan Lee, Westfield, IN (US)

Correspondence Address: Joseph J. Laks;Thomson Licensing LLC, 2 Independence Way, Patent Operations, PO Box 5312, PRINCETON, NJ, 08543, US

(73) Assignee: THOMAS LICENSING, Boulogne-Billancourt (FR)

(21) Appl. No.: 11/660,063

(22) PCT Filed: Aug. 25, 2004
(86) PCT No.: PCT/US04/27697

§ 371 Date: Feb. 12, 2007

(51) Int. Cl. H04N 5/50; H04N 7/26

(52) U.S. Cl. 348/731; 375/240.25; 348/E05.097

(57) ABSTRACT

An apparatus for changing a channel of a digital input stream includes decoding hardware for reinitializing video decoding variables and decoding video data in response to new data input from a video stream; and storage for video content of a channel of said buffer being displayed until said new data input from a vide stream by said video decoder and allocated to said buffer.

This application claims the benefit, under 35 U.S.C. § 365 of International Application PCT/US2004/027697, filed Aug. 25, 2004, which was published in accordance with PCT Article 21(2) on Mar. 9, 2006 in English.

### FIELD OF THE INVENTION

The present invention relates generally to digital television systems and, more particularly, to fast channel changing by switching the active packet identifiers PIDs.

### DESCRIPTION OF THE RELATED ART

Typical procedures to start and stop the video when a digital channel is changed involves getting channel buffer information, allocating channel buffer resources, selecting de-multiplexer packet identifiers, getting MPEG header information, allocating the display buffer and starting the video display. This involved procedure for starting and stopping the video during channel changing results in increased channel changing time and increased blanking time during a channel change. The increased channel changing time is much too long compared to the channel changing time for an analog television.

Accordingly, there is a need for fast channel changing time for digital video stream applications.

### SUMMARY OF THE INVENTION

An apparatus for changing a channel of a digital input stream includes decoding hardware for reinitializing video decoding variables and decoding video data in response to new data input from a video stream; and storage for video content extracted by the decoding hardware to be displayed by a display device, current video content of a channel of the buffer being displayed until the new data input is extracted from a valid video stream by the video decoder and allocated to the buffer.

A method for changing a channel of a digital input stream includes the steps of receiving a digital input; filtering the digital input responsive to a selective channel of information from the digital input; detecting digital video information from the digital input; and allocating the digital video information to memory for display.

A method for transitioning from analog channel changing to digital channel changing including the steps of stopping display of analog video; receiving digital input; restarting de-multiplexer processing of the digital input with a prior channel buffer; changing packet identifiers for filtering output from the de-multiplexing processing of the digital input; and adjusting a display filter for digital information obtained from the filtering.

### BRIEF DESCRIPTION OF THE DRAWINGS

A more complete understanding of the present invention may be obtained from consideration of the following description in conjunction with the drawings, in which:

FIG. 1 is a block diagram of an exemplary hardware configuration in a television for implementing the inventive digital channel changing;

FIG. 2 is an exemplary state transition diagram showing differences between analog channel changing and digital channel changing in accordance with the invention;

FIG. 3 is a flow diagram of steps for stopping a process from channel changing in accordance with the invention; and

FIG. 4 is a flow diagram of the steps for starting a process of channel changing in accordance with the invention.

To facilitate understanding, identical reference numerals have been used, where possible, to designate identical elements that are common to the figures.

### DETAILED DESCRIPTION

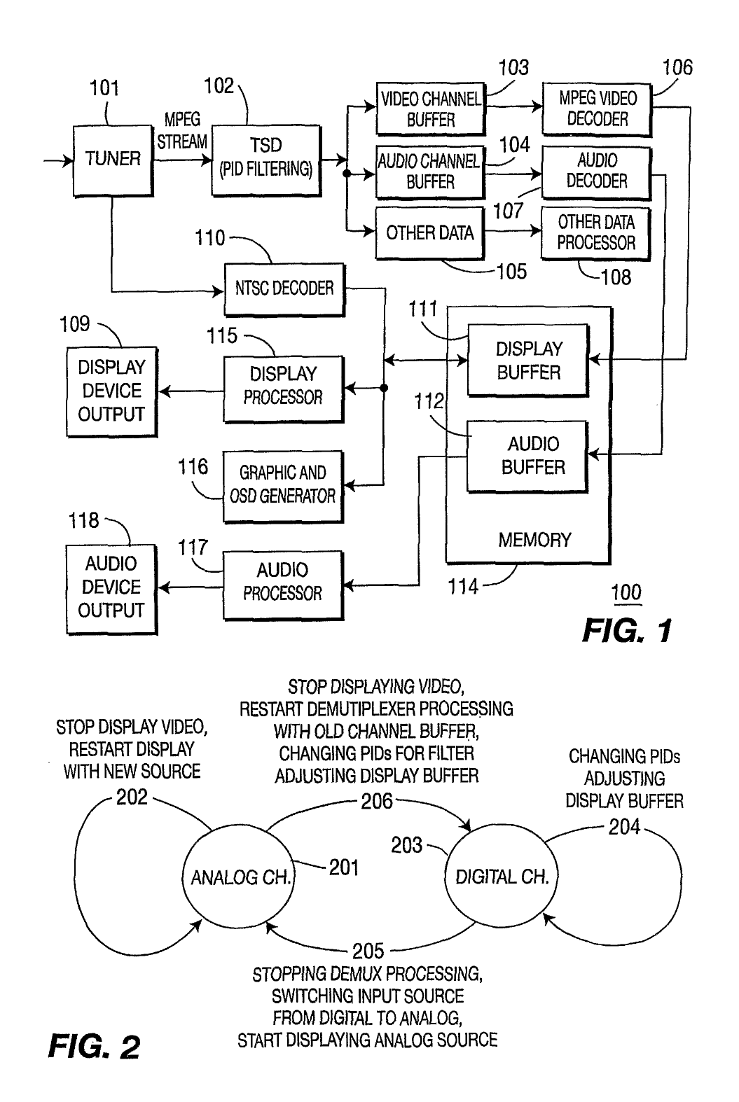

Referring to FIG. 1 there is shown a block diagram 100 of an exemplary hardware configuration in a television for implementing the inventive channel changing. The hardware configuration includes a digital video processing path in parallel with an analog video processing path. In the digital video processing path, an MPEG stream received at the tuner 101 is decoded by the transport stream decoder 102 that performs packet identifier PID filtering. The transport stream decoder 102 extracts video, audio and other data from the MPEG stream. The extracted video is sent to a video channel buffer 103, the extracted audio is sent to an audio channel buffer 104 and the other data is sent to a corresponding other data buffer 105. It is reserved for other data communication. Actually, we can share the stream with data. And it looks like we have other formats in DSM-cc or DASE standard. Information in the video channel buffer 103 is decoded at an MPEG video decoder 106 and sent to the display buffer 111 portion of the memory 114. The display buffer 111 information is then processed by the display processor 115 and graphic and on screen display generator 116 for display at the display output device 109. Information in the audio channel buffer 104 is decoded at the audio decoder 107, then sent to an audio buffer 112 where it can be retrieved for processing by an audio processor 117 and played by an audio device output 118. the other data 108 is sent to an other data processor 108. We can have other application with this data communication. It is not defined as video or audio, so it could be any type of data. In the analog video processing path, the video stream received at the tuner 101 is decoded by the NTSC decoder 110 and sent to the display processor and graphic and on screen display OSD generator 115 tied to a display device output.

In a digital TV system, for reducing the channel changing time, the content of a current channel buffer can be displayed until new input data can be obtained. After getting new input data, the system can reinitialize the video decoding variables and data structures and restart to decode and display with the new data. The screen can be frozen at the last frame from the last channel data if a valid video stream from new inputs cannot be found. A few frames can be added during blanking whenever the system finds a new valid MPEG header for avoiding the unstable frames on the screen after switching to new inputs.

This procedure provides for fast enough switching whenever the channel is changed within the same program association table PAT, in the case of sub-channel changing. This procedure also works for digital channel to digital channel even when the physical channel in the tuner is changed. If the tuning time in a tuner is not fast enough, the only difference that can be seen is a few frozen frames from the prior channel.

Switching to or from an analog channel requires a few steps more than in the case of digital-to-digital channel changing. Referring to FIG. 2, an exemplary state transition diagram 200 shows differences in process steps for changing channels in both analog video input and digital video input, and moving between analog and digital channel changing operations.

In the analog channel changing mode 201, the displayed video is stopped and the display is restarted with a new video source 202. In moving from analog channel to digital channel 203 the system stops displaying video, restarts de-multiplexer processing with the old channel buffer, changes packet identifiers PIDs for the filter, and adjusts the displaying filter 206. Once in the digital channel changing mode 203, the system changes packet identifiers and adjusts the display buffer 104. Moving from digital channel changing to analog channel changing involves stopping the de-mutliplexing processing, switching the video input source from digital to analog, and start displaying the analog source 205.

The state transition diagram 200 shows that the system need only stop getting data and leave the channel buffer, when a transit to an analog channel is made, and restart with that channel buffer after flushing when a transit to a digital channel is made so the system can save the time to reallocation of the channel buffer and create new data structures

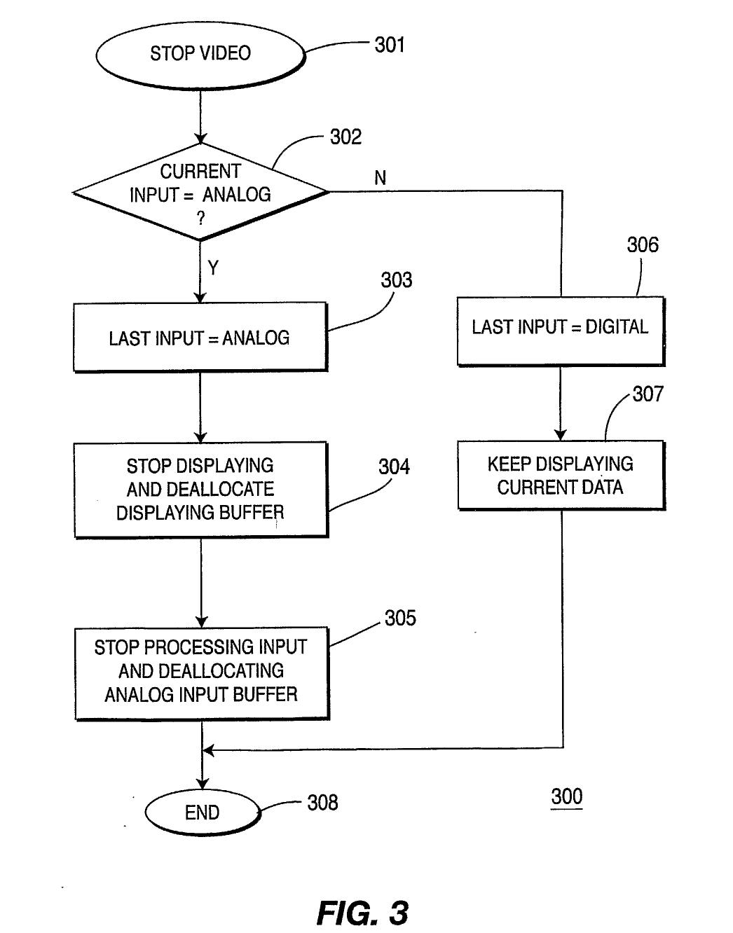

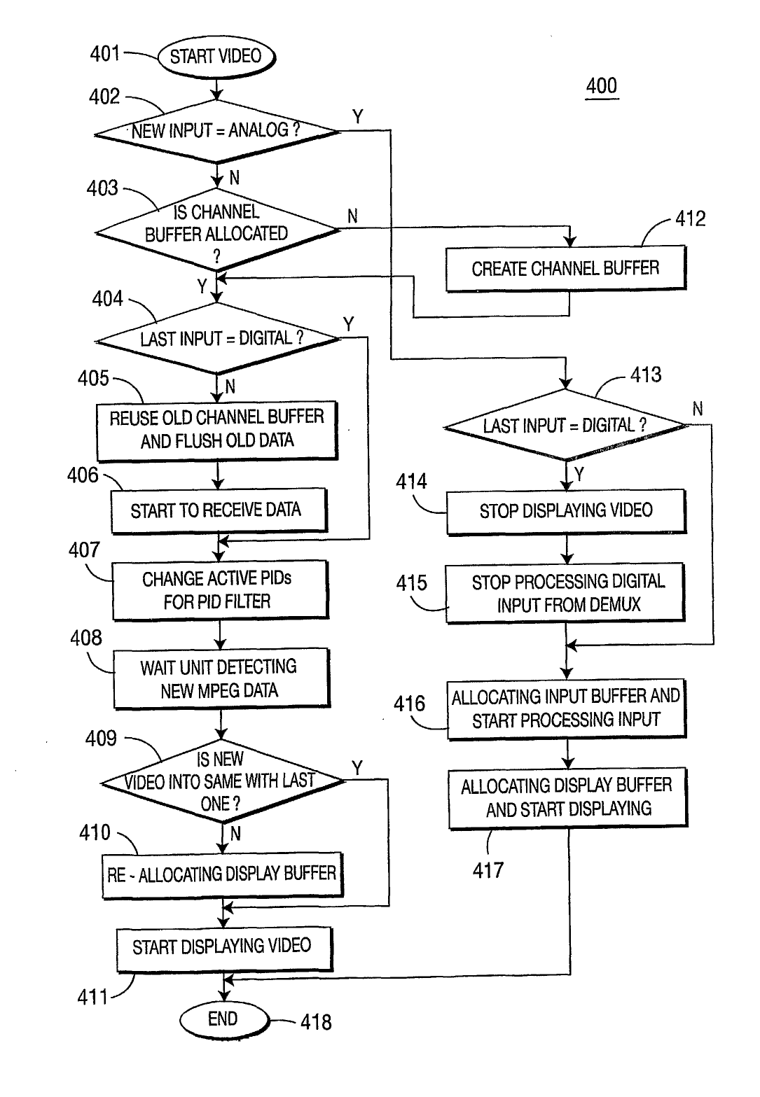

Changing a digital channel in accordance with the invention requires two distinct processing modes by the digital system: stop system processing from channel changing, FIG. 3, and start system process for channel changing, FIG. 4.

Referring to the flow diagram 300 of FIG. 3, the video input is stopped 301 and a check is made whether the current video input is an analog input 202. If the input is not an analog input, then the last input is a digital input 206 and the system is configured to keep displaying the current program data 207. Where the current video input is an analog input, then the last input is an analog input 203. The system is configured to stop displaying from the display buffer, de-allocate the display buffer 204. The system is further configured to stop processing the digital program input and de-allocating the analog input buffer 205.

In summary, FIG. 3 shows that the procedure for stopping the process in the video driver is to just stay with the previous channel data if it is digital channel. The procedure stops the display input source and de-allocates the display buffer if it is analog input and then stops processing inputs. The last input type for the starting process is saved.

The block diagram 400 of FIG. 4 shows that the procedure for the starting process for channel changing depends on the input type. As noted in the state transition diagram, the process path depends on the input source type, analog or digital, and the last input type in either case.

Upon starting the video input 401, if the new input is digital 402 then a check of the channel buffer is made first because the channel buffer is not allocated for first time 403. If a channel buffer is not allocated 403, the process creates a channel buffer 412 for first time and the channel buffer will last until the processor is reset or a severe problem is detected. If the last input was an analog input 404, then the old channel buffer is re-used and old data is flushed 405 and data is received 406. If the last input was a digital input 404 then the process jumps right to the de-multiplexing 407. The de-multiplexer process including changing active packet identifiers PIDs for the PID filter 407 and the process then the process waits until new MPEG data is detected 408. If the new video information is the same as the last video information 409 then the video displaying is started 411. If the new video information is different from the last video information then the display buffer is reallocated to hold the new video information prior to the video display starting 411.

And with analog inputs, the process checks the last input. If the last input was digital, then it stops displaying and de-multiplexing and then processes the new analog input and starts displaying the new inputs. More specifically, If the new input is an analog input 402 and the last input was an analog input the input buffer is allocated with the analog input data for processing 416 and the display buffer is allocated with the processed analog input data for display 417. If the new input is an analog input 402 and the last input was a digital input 413 the video display is stopped 414 and processing digital input from the de-multiplexing process is stopped 415. Then allocation of the input buffer for processing the input 416 followed by allocation of the display buffer and starting the displaying of the analog video 417.

Although various embodiments which incorporate the teachings of the present invention have been shown and described in detail herein, those skilled in the art can readily devise many other varied embodiments that will still incorporate these teachings.

1. An apparatus for changing a channel of a digital input stream comprising:
decoding hardware for reinitializing video decoding variables and decoding video data in response to new data input from a video stream; and
storage for video content decoded by said decoding hardware to be displayed by a display device, said storage maintaining current video content for display until receipt of new data decoded by said decoding hardware.

2. The apparatus according to claim 1, wherein said decoding hardware comprises packet identifier filtering.

3. The apparatus according to claim 2, wherein said packet identifier filtering switches only active packet identifiers responsive to channel changes corresponding to changes in said data input.

4. The apparatus according to claim 1, wherein said video decoder comprises a transport stream decoder for extracting digital video from a video stream received, said transport stream decoder including packet identifier filtering.

5. The apparatus according to claim 3, wherein said packet identifier filter is responsive to channel changes corresponding to changes in said data input.

6. A method for changing a channel of a digital input stream comprising the steps of:
receiving a digital input;
filtering said digital input responsive to a selective channel of information from said digital input;
detecting digital video information from said digital input; and
allocating said digital video information to memory for display.

7. The method of claim 6, wherein said filtering comprises packet identifier filtering responsive to said selective channel.

8. The method of claim 6, wherein said filtering comprises changing active packet identifiers for packet identifier filtering for said digital input.

9. The method according to claim 6, wherein said step of detecting comprises MPEG video decoding to obtain said digital video information.

10. The method of claim 6, wherein said step of filtering is carried out by a transport stream decoder including packet identifier filtering.

11. The method of claim 6, wherein said step of receiving a digital input follows a prior input being an analog input, said step of receiving a digital input is followed by the step of allocating memory for storing said digital input prior to said step of filtering said digital input.

12. The method of claim 6, wherein said step of allocating said digital video information to memory for display includes first determining that said digital information is different from previous digital information detected and needing allocation to memory for display.

13. A method for transitioning from analog channel changing to digital channel changing comprising the steps of:
stopping display of analog video;
receiving digital input,
restarting de-multiplexer processing of said digital input with a prior channel buffer;
changing packet identifiers for filtering output from said de-multiplexing processing of said digital input; and
adjusting a display filter for digital information obtained from said filtering.

14. The method of claim 13, wherein said filtering is carried out by a transport stream decoder with packet identifier filtering.

15. The method of claim 13, wherein said de-multiplexer processing is carried out by a transport stream decoder.

16. The method of claim 13, wherein said step of adjusting a display filter is includes MPEG decoding output from said filtering.
